(19) United States
(12) Patent Application Publication
(10) Pub. No.: US 2002/0070321 A1
(43) Pub. Date: Jun. 13, 2002

(54) Sign post

(76) Inventor: Robert J. Womack, Phoenix, AZ (US)

Correspondence Address: William J. Foley, CAHILL, SUTTON & THOMAS P.L.C., 155 Park One, 2141 E. Highland Avenue, Phoenix, AZ, 85016, US

(21) Appl. No.: 09/734,468

(22) Filed: Dec. 12, 2000

(51) Int. Cl. A45F 3/44; E02D 5/74; G09F 15/00

(52) U.S. Cl. 248/156; 40/607; 40/606; 52/388; 52/165

(57) ABSTRACT

A sign post is comprised of two principal components, namely a lower tubular member and an upper tubular member which is telescoped over the lower member. The lower member has ground penetrating members at its lower end. A striker plate in an upper region of the upper member is adapted to strike an anvil plate closed upper end of the lower member when the upper member is reciprocated on the lower member to drive the ground penetrating members into the ground. A pin arrangement permits the upper member to be locked in different positions on the lower member.

### TECHNICAL FIELD

This invention is concerned with portable posts to support signs above the ground.

### BACKGROUND ART

Installation of conventional wooden real estate sign posts usually requires that a post hole be dug before the post is erected. And the post itself is heavy and cumbersome to handle. Installation is also usually beyond the capabilities of real estate service personnel so they go to the trouble and expense of contracting out the sign installation task.

Efforts have been expended to devise posts which are lighter in weight and easier to install. U.S. Pat. No. 4,279,104 granted Jul. 21, 1981 to A. T. Classen for “Sign Post Construction Having Reciprocable Driver For Placement and Removal” discloses one such post. Another is disclosed in U.S. Pat. No. 4,910,901 granted Mar. 27, 1990 to F. E. Boyar for “Sign Post Assembly”. And yet another in U.S. Pat. No. 5,722,205 granted Mar. 3, 1998 to R. M. Gannaway for “Self-Installing Post”.

There continues to be a need for a sign post which is easy to install and can be reliably used over and over again.

### SUMMARY OF THE INVENTION

The invention contemplates a post having two predominately tubular members, or components. A lower member has ground penetrating means at its lower end and a closed upper end. Telescoped over the lower member is a tubular upper member having a striker member in an upper region for contacting the closed end of the lower member when the upper member is reciprocated on the lower member to drive the ground penetrating means into the ground. The upper member has an opening therein near its lower end to receive a pin for cooperation with a plurality of openings in the lower member and spaced along its length. The pin is inserted in the lowermost opening in the lower member for storage and transport of the post. The pin is placed in other openings in the lower member to hold the upper member in selected elevated positions.

### BRIEF DESCRIPTION OF THE DRAWINGS

The invention is described in greater detail hereafter by reference to the accompanying drawings wherein:

FIG. 1 is an elevational view of the post of the invention in use to support a sign;

FIG. 2 is an exploded elevational view of a lower member of the post;

FIG. 3 is an exploded elevational view of an upper member of the post;

FIG. 4 is an elevational view of the assembled post in a storage and transport condition;

FIG. 5 is an enlarged sectional view of the post taken as indicated by line 5-5 in FIG. 4; and

FIG. 6 is an elevational view of a modified upper member of the post.

### BEST MODE FOR CARRYING OUT THE INVENTION

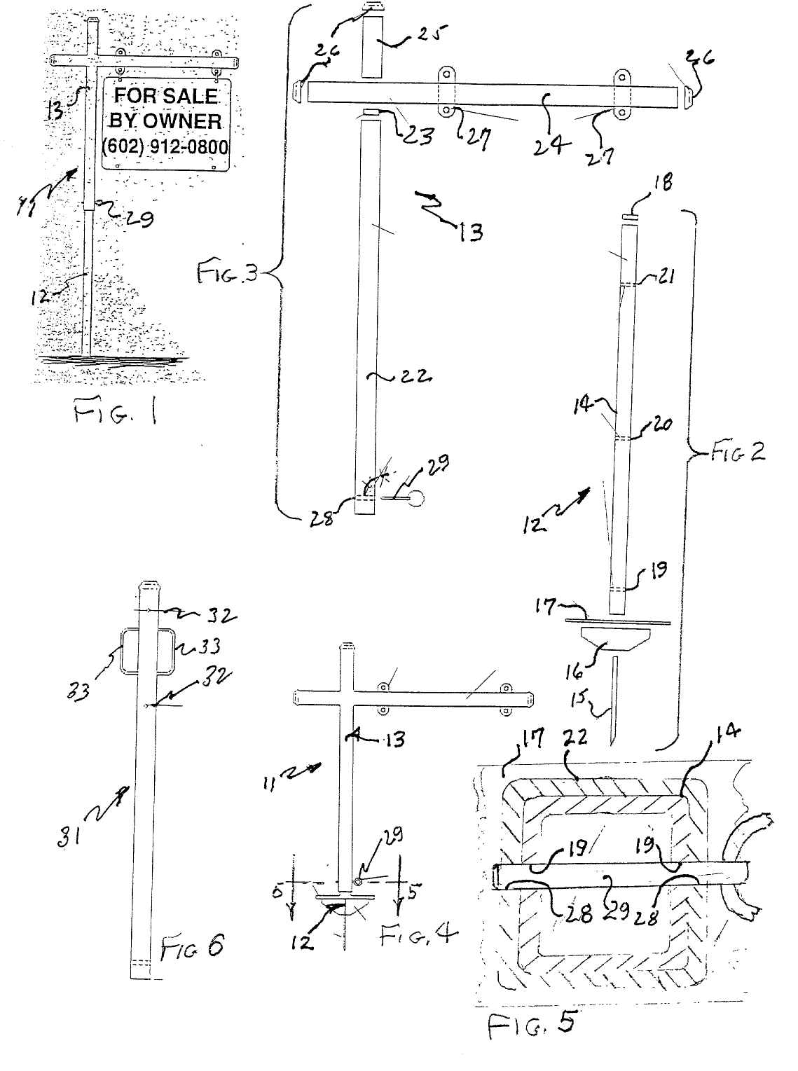

Referring particularly to FIG. 1, the sign post of this invention is designated generally by reference numeral 11. Post 11 comprises two major components, namely, a lower member 12 and an upper member 13. Both members 12 and 13 are fabricated predominately from hollow, rectangular steel tubing.

The construction of the lower member 12 is illustrated in FIG. 2 and comprises a tubular body 14 having ground penetrating means affixed to its lower end. The ground penetrating means includes a spike 15 in the form of a sharpened steel rod and a spade 16 fashioned from sheet steel. The spike 15 and spade 16 of the ground penetrating means cooperate to hold the lower member 12 upright in the ground and prevent it from turning about its longitudinal axis. The lower member may also have a foot plate 17 at its lower end which engages the surface of the ground and further stabilizes the lower member in an upright position.

The upper end of body 14 of lower member 12 is completely closed by a steel anvil plate 18.

A series of openings are drilled through the walls of member body 14 at spaced intervals as indicated schematically by the dashed lines in FIG. 2. One opening 19 is near the lower end of body 14. Other openings 20 and 21 are spaced upwardly along the body 14.

The spike 15, the spade 16, the foot plate 17 and the anvil plate 18 are all securely welded to the body 14.

The construction of the upper member 13 is illustrated in FIG. 3. The main body 22 of upper member 13 is of hollow rectangular steel tubing sized to slide smoothly over the length of the body 14 of lower member 12 (see FIG. 5).

The upper member 13 further includes a striker plate 23 near the upper end of body 22, a tubular cross-arm 24 and a tubular crown post 25. Stamped steel end caps 26 are provided for closing the open ends of the cross-arm 24 and the crown post 25. And sign brackets 27 are secured to the cross arm 24.

All of the several components of the upper member 13 are preferably securely welded to adjacent components to provide a strong rigid structure.

Near the lower end of the body 22 of the upper member 13 are a pair of opposite openings 28 drilled through the walls of the body. The openings are indicated schematically by the dash lines in FIG. 3 (see also FIG. 5).

The openings 28 in upper member body 22 are intended to be selectively aligned with each of the openings 19, 20 and 21 in lower member body 14 to receive a pin 29 for the purpose of locking the upper member 13 in selected positions on the lower member 12.

With pin 29 passing through openings 28 in upper member 13 and openings 19 in the lower member 12 the two members are locked together in their most compact configuration for storage and/or transport. This is the configuration depicted in FIG. 4.

With pin 29 passing through openings 28 in upper member 13 and either openings 20 or 21 in lower member 12 the two members are locked together in a condition in which the cross-arm 24 of the upper member is elevated above the ground, for example, as shown in FIG. 1.

Installation of the sign post 11 involves first selecting a site away from sprinkler lines and buried service wires and pipes. The post 11 is placed upright over the site selected and pin 29 is removed. The installer then reciprocates the upper member 13 up and down on the body 14 of the lower member 12. This movement causes the striker plate 23 in the upper member to repeatedly strike the anvil plate 18 in the upper end of the lower member driving the spike 15 and spade 16 into the ground until the footplate 17 contacts the ground.

It is important that the upper end of lower member body 14 be closed with a strong and securely affixed anvil plate 18. With this construction swaging of the upper end of body 14 is avoided even with repeated installations of the post 11. Were the end of body 14 swaged it could expand, become wedged in the body 22 of upper member 13 and prevent proper use of the post.

Removal of the post 11 is effected by placing pin 29 in the lowermost openings 19 in the lower member body 14 and pulling the post straight up. If any difficulty is experienced, the pin 29 is removed, and two or three blows are struck with the upper member 13 to loosen the soil. The post is then repinned and pulled from the ground.

The post of this invention can be employed to display signs other than the conventional real estate sign shown in FIG. 1 or employed as a utility post. The upper member of such a post is illustrated in FIG. 6 and identified generally by reference numeral 31. Member 31 has no cross-arm, but may be provided with screw or bolt holes 32 to receive sign or other fasteners. Member 31 may also be provided with handles 33 to be grasped to facilitate reciprocating the member up and down on a spiked lower member such as that illustrated in FIG. 2.

From the foregoing it should be apparent that this invention provides an improved sign post which is completely portable, requires no digging, requires no tools, is adjustable, easily removed and is suitable for temporary and permanent uses.

What is claimed is

1. Apparatus for holding a sign, comprising:
a lower tubular member having ground penetrating means at its lower end and a closed upper end;
an upper tubular member telescoped over said lower tubular member for reciprocating movement thereon;
a striker member in an upper region of said upper tubular member and adapted to strike the closed end of the lower tubular member when the upper tubular member is reciprocated on the lower tubular member for the purpose of driving said penetrating means into the ground;
said lower tubular member having a plurality of openings spaced along its length;
said upper tubular member having an opening in a lower region thereof which can be aligned with selected ones of the openings in said lower tubular member; and
pin means removably insertable into the openings in the upper and lower tubular members.

2. Apparatus of claim 1 further characterized in that
said ground penetrating means comprises a spike, and
a spade.

3. Apparatus of claim 1 further comprising:
a cross-arm affixed to an upper region of said upper tubular member.

4. Apparatus of claim 1 further comprising
handle means affixed to an upper region of said upper tubular member.
